(19) United States
(12) Patent Application Publication
(10) Pub. No.: US 2016/0178655 A1
(43) Pub. Date: Jun. 23, 2016

(54) THIN FILM SUPERCONDUCTING ACCELERATION MEASURING APPARATUS

(71) Applicant: KOREA RESEARCH INSTITUTE OF STANDARDS AND SCIENCE, Daejeon (KR)

(72) Inventor: In-seon Kim, Daejeon (KR)

(21) Appl. No.: 15/056,362

(22) Filed: Feb. 29, 2016

Related U.S. Application Data
(63) Continuation of application No. PCT/KR2014/008351, filed on Sep. 5, 2014.

(30) Foreign Application Priority Data
Sep. 13, 2013 (KR) 10-2013-0110598

(51) Int. Cl. G01P 15/105; H01F 6/06; H01F 6/04; G01P 15/11

(52) U.S. Cl. CPC G01P 15/105; G01P 15/11; H01F 6/06; H01F 6/04

(57) ABSTRACT

An acceleration measuring apparatus, a SQUID sensor module, and a fabrication method of the SQUID sensor module. The acceleration measuring apparatus includes a test mass structure with a superconducting thin film on its one surface and providing elasticity, a superconducting coil for measurement disposed on the substrate to be opposite to the one surface of the test mass structure and magnetically coupled to the test mass structure, a transformer disposed on the substrate and including a primary superconducting coil connected to the superconducting coil and a secondary superconducting coil magnetically coupled to the primary superconducting coil, an input coil disposed on the substrate and connected to the secondary superconducting coil, and a superconducting quantum interference device (SQUID) disposed on the substrate and magnetically coupled to the input coil.

### CROSS-REFERENCE TO RELATED APPLICATIONS

This application is a continuation of and claims priority to PCT/KR2014/008351 filed on Sep. 5, 2014, which claims priority to Korea Patent Application No. 10-2013-0110598 filed on Sep. 13, 2013, the entireties of which are both hereby incorporated by reference herein.

### BACKGROUND

1. Technical Field

The present disclosure generally relates to superconducting acceleration measuring apparatuses and, more particularly, to a superconducting acceleration measuring apparatus for measuring small displacement using a superconducting thin film coil.

2. Description of the Related Art

A typical accelerometer includes a test mass suspended from a spring. When gravity variation or acceleration variation arises, the test mass may move and measure the amount of moving small displacement to show gravity variation or acceleration variation.

A superconductor has zero electrical resistance, and its internal magnetic field becomes zero. The latter is called “Meissner effect”, and the superconductor has a diamagnetic property that is resistant to an external magnetic field. For example, a magnetic on a superconductor (or a superconductor on a magnet) floats in the air due to the diamagnetic effect.

### SUMMARY

A subject matter of the present disclosure is to provide an ultra-compact superconducting acceleration measuring apparatus for measuring small displacement by applying a thin film superconducting coil.

An acceleration measuring apparatus according to an embodiment of the present disclosure may include: a test mass structure with a superconducting thin film on its one surface and providing elasticity; a superconducting coil for measurement disposed on the substrate to be opposite to the one surface of the test mass structure and magnetically coupled to the test mass structure; a transformer disposed on the substrate and including a primary superconducting coil connected to the superconducting coil and a secondary superconducting coil magnetically coupled to the primary superconducting coil; an input coil disposed on the substrate and connected to the secondary superconducting coil; and a superconducting quantum interference device (SQUID) disposed on the substrate and magnetically coupled to the input coil.

In an example embodiment, the test mass structure may include at least one slit as proceeding from its central axis in a radial direction. The slit may have constant width. An angle between a start point and an end point of the slit may be 90 degree or greater on the basis of the center of the test mass structure.

In an example embodiment, the test mass structure may include first to fourth slits disposed by 90-degree rotation with respect to each other. The first slit may include: a first branch having a first radius and extending in an azimuthal direction in the first quadrant; a second branch having a second radius greater than the first radius and extending in the azimuthal direction in the second quadrant; and a linear branch extending in a radius direction to connect one end of the first branch to one end of the second branch.

In an example embodiment, the test mass structure may include: a test mass disposed at an inner side of the slit; a support disposed at an outer side of the slit; and a membrane spring between an inner side region and an outer side region. Thickness of the membrane spring may be greater than thickness of the test mass and thickness of the support. The superconducting thin film may be disposed on a bottom surface of the test mass.

In an example embodiment, the bottom surface of the test mass may be dented.

In an example embodiment, the test mass structure may include first to fourth slits disposed by 90-degree rotation with respect to each other. The first slit may include a first branch having a first radius and extending in an azimuthal direction in the first quadrant; a second branch having a second radius greater than the first radius and extending in the azimuthal direction in the second quadrant; a third branch having a third radius greater than the second radius and extending in the azimuthal direction in the first quadrant; and a linear branch extending in a radial direction to connect one end of the first branch, one end of the second branch, and one end of the third branch to each other.

In an example embodiment, the acceleration measuring apparatus may further include a back surface superconducting thin film disposed on a bottom surface of the substrate.

In an example embodiment, the acceleration measuring apparatus may further include a guide ring disposed around the superconducting coil for measurement to align the test mass and the superconducting coil for measurement.

In an example embodiment, test mass structure may include a membrane spring.

An acceleration measuring apparatus according to another embodiment of the present disclosure may include a test mass structure including a test mass with a superconducting thin film on its bottom surface and a membrane spring providing elasticity to the test mass, the test mass structure being formed in one body, and a superconducting quantum interference device (SQUID) sensor module including a superconducting coil for measurement, a transformer, an input coil, and a SQUID and measuring variation of permanent current depending on displacement between the test mass and the superconducting coil.

In an example embodiment, the acceleration measuring apparatus further includes: at least one of a superconducting case storing the test mass structure and the SQUID sensor module; a vacuum can storing the superconducting case and filled with a helium gas; an outer container receiving the vacuum can, the inside of the outer container being maintained at a vacuum state; a heat transfer medium thermally contacting the superconducting case to cool the superconducting case; and a cryocooler thermally contacting the heat transfer medium and disposed outside the outer container.

In an example embodiment, the acceleration measuring apparatus may further include at least one of a superconducting case storing the test mass structure and the SQUID sensor module; a vacuum can storing the superconducting case and filled with a helium gas; an inner container receiving the vacuum can and filled with a coolant; and an outer container receiving the inner container and maintained at a vacuum state.

A SQUID sensor module according to an embodiment of the present disclosure may include: a superconducting coil for measurement disposed on a substrate and magnetically coupled to an external measurement target; a transformer disposed on the substrate and including a primary superconducting coil connected to the superconducting coil and a secondary superconducting coil magnetically coupled to the primary superconducting coil; an input coil disposed on the substrate and connected to the secondary superconducting coil; and a superconducting quantum interference device (SQUID) disposed on the substrate and magnetically coupled to the input coil.

In an example embodiment, the SQUID sensor module may further include a permanent current injection pad disposed on an interconnection connecting the primary superconducting coil and the superconducting coil for measurement to each other.

In an example embodiment, the SQUID sensor module may further include a first resistance pattern disposed on an interconnection connecting the primary superconducting coil and the superconducting coil for measurement to each other; and a first heat switch pad disposed on the first resistance pattern.

In an example embodiment, the SQUID sensor module may further include a second resistance pattern disposed on an interconnection connecting the secondary superconducting coil and the input coil to each other; and a second heat switch pad disposed on the second resistance pattern.

In an example embodiment, the SQUID sensor module may further include a first interconnection disposed below the primary superconducting coil and the superconducting coil for measured and connected to the primary superconducting coil and the superconducting coil for measured through a via; a second interconnection connecting the superconducting coil for measurement and the primary superconducting coil to each other; a third interconnection connecting the secondary superconducting coil and the input coil to each other; and a fourth interconnection connecting the secondary superconducting coil and the input coil to each other through a via.

A fabrication method of a SQUID sensor according to an embodiment of the present disclosure may include: forming a SQUID on a substrate; forming a superconducting coil for measurement on the substrate, the superconducting coil for measurement being spaced apart from the SQUID and formed of a superconductor; forming a primary superconducting coil of a transformer disposed on the substrate and connected to the superconducting coil for measurement; forming a secondary superconducting coil of the transformer magnetically coupled to the primary superconducting coil; and forming an input coil magnetically coupled to the SQUID, disposed on the substrate, and connected to the secondary superconducting coil of the transformer.

In an example embodiment, the superconducting coil for measurement and the primary superconducting coil may be formed at the same time.

In an example embodiment, the secondary superconducting coil and the input coil may be formed at the same time.

According to the above-described embodiments of the present disclosure, an accelerating measuring apparatus of a thin film superconducting coil may improve flatness of a coil to provide more accurate acceleration measurement. In addition, an ultra-compact integrated assembled superconducting acceleration measuring apparatus may be implemented.

### BRIEF DESCRIPTION OF THE DRAWINGS

The present disclosure will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the present disclosure.

FIG. 1 is a conceptual diagram of an acceleration measuring apparatus according to an embodiment of the present disclosure.

FIGS. 2A through 2D are circuit diagrams illustrating operation of an acceleration measuring apparatus according to an embodiment of the present disclosure.

FIG. 3A is a top plan view of a test mass structure according to an embodiment of the present disclosure.

FIG. 3B is a cross-sectional view taken along the line I-I′ in FIG. 3A.

FIG. 3C is a cross-sectional view taken along the line II-II′ in FIG. 3A.

FIGS. 4A and 4B are cross-sectional views of a superconducting acceleration measuring apparatus according to an embodiment of the present disclosure.

FIG. 5 is a top plan view of a test mass structure according to another embodiment of the present disclosure.

FIGS. 6 and 7 illustrate acceleration measuring apparatuses according to embodiments of the present disclosure, respectively.

FIG. 8A is a top plan view of a SQUID sensor module according to an embodiment of the present disclosure.

FIG. 8B is a cross-sectional view taken along the line in FIG. 8A.

FIGS. 9A through 9O are cross-sectional views illustrating a method of manufacturing the SQUID sensor module shown in FIG. 8A.

### DETAILED DESCRIPTION

Advantages and features of the present disclosure and methods of achieving them will be apparent from the following exemplary embodiments that will be described in more detail with reference to the accompanying drawings. It should be noted, however, that the present disclosure is not limited to the following exemplary embodiments, and may be implemented in various forms. Accordingly, the exemplary embodiments are provided only to disclose the present disclosure and let those skilled in the art know the category of the present disclosure.

In the specification, it will be understood that when an element is referred to as being “on” another layer or substrate, it can be directly on the other element, or intervening elements may also be present. In the drawings, thicknesses of elements are exaggerated for clarity of illustration.

Exemplary embodiments of the disclosure herein will be described below with reference to cross-sectional views, which are exemplary drawings of the disclosure herein. The exemplary drawings may be modified by manufacturing techniques and/or tolerances. Accordingly, the exemplary embodiments of the disclosure herein are not limited to specific configurations shown in the drawings, and include modifications based on the method of manufacturing the semiconductor device. For example, an etched region shown at a right angle may be formed in a rounded shape or formed to have a predetermined curvature. Therefore, regions shown in the drawings have schematic characteristics. In addition, the shapes of the regions shown in the drawings exemplify specific shapes of regions in an element, and do not limit the disclosure herein. Though terms like a first, a second, and a third are used to describe various elements in various embodiments of the present disclosure, the elements are not limited to these terms. These terms are used only to tell one element from another element. An embodiment described and exemplified herein includes a complementary embodiment thereof.

The terms used in the specification are for the purpose of describing particular embodiments only and are not intended to be limiting of the disclosure herein. As used in the specification, the singular forms “a”, “an” and “the” are intended to include the plural forms as well, unless the context clearly indicates otherwise. It will be further understood that the terms “comprises” and/or “comprising”, when used in the specification, specify the presence of stated features, integers, steps, operations, elements, and/or components, but do not preclude the presence or addition of one or more other features, integers, steps, operations, elements, components, and/or groups thereof.

Hereinafter, embodiments of the present disclosure will now be described more fully with reference to accompanying drawings.

If current is made to flow to a superconducting coil for measurement made of a superconducting conductor and a closed loop circuit is formed, electrical resistance of the superconducting coil is zero. Therefore, permanent current flows for an infinite time. At this point, when a test mass including a superconducting thin film adjacent to the superconducting coil moves, an inductance of the superconducting coil varies due to the diamagnetic effect and the flux quantization effect of a superconductor. Accordingly, superconducting permanent current varies. That is, by measuring current variation, small displacement of the superconductor may be measured to measure gravity variation or acceleration variation.

A superconducting accelerometer according to an embodiment of the present disclosure may be formed using a semiconductor integration process. The superconducting accelerometer may include a test mass structure with a superconducting thin film on its one surface and providing elasticity.

The test mass structure may include a spring manufactured using a membrane and a test mass having a bottom formed of a superconducting thin film. A superconducting quantum interference device (hereinafter referred to as “SQUID”) sensor module may sense current variation depending on variation of a distance between a superconducting coil for measurement manufactured using a thin film and a test mass. The superconducting coil and an input coil of the SQUID sensor are magnetically coupled through a transformer. A heat switch is disposed on a substrate to drive the superconducting coil and protect the SQUID sensor from overcurrent.

When acceleration of the test mass structure varies, the test mass moves. Thus, the accelerometer measures the moving distance (small displacement).

A test mass structure may magnetically float using a superconducting phenomenon. When the test mass structure including a superconductor moves, inductance of a superconducting coil disposed adjacent to the test mass structure varies. The inductance variation changes current flowing to the superconducting coil to constantly maintain stored energy. Thus, the current flowing to the superconducting coil varies a magnetic field and the current or the magnetic field is converted into a voltage by a SQUID sensor through a transformer or a converter.

A conventional superconducting accelerometer includes a pancake coil formed by winding a niobium wire having a diameter of 0.125 mm, a transformer, a heat switch, and other components. These components are separately manufactured and mechanically combined with each other. For this reason, the conventional superconducting accelerometer is significantly large in volume and significantly low in precision. Accordingly, an embodiment of the present disclosure proposes a test mass structure where a test mass and a membrane spring are formed in one body. The test mass structure may be manufactured by a micro-electro-mechanical systems (MEMS) process or a semiconductor process. The pancake coil, the transformer, the heat switch, a SQUID, and the input coil may be integrated in a body into a substrate. Thus, an accurate accelerometer with small volume may be implemented.

An acceleration measuring apparatus according to an embodiment of the present disclosure may be manufactured by a thin-film process.

A superconducting coil for measurement according to an embodiment of the present disclosure may be in the form of a pancake coil and may be formed of a niobium (Nb) thin film to improve coil flatness. In case of a niobium wire coil having a diameter of 0.125 mm, flatness is about half the diameter. However, according to an embodiment of the present disclosure, a thin-film superconducting coil for measurement, a SQUID, and other components may be fabricated into a single chip on the same substrate by a thin-film process. Thus, coil flatness is high.

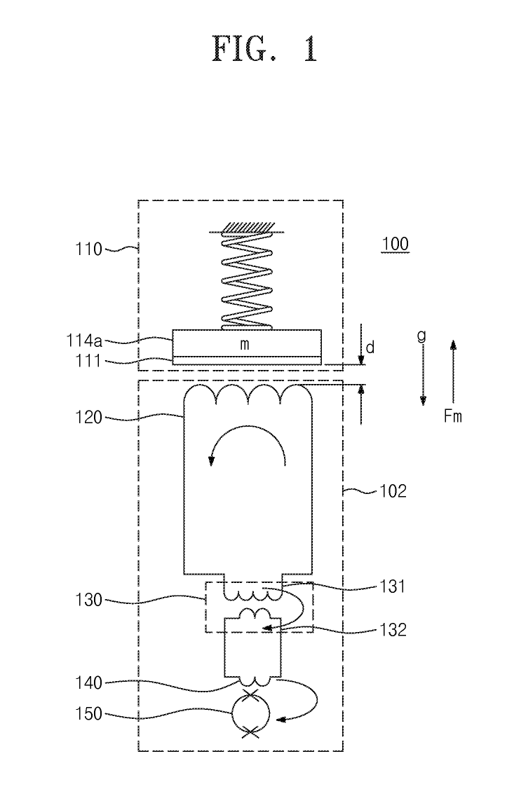

FIG. 1 is a conceptual diagram of an acceleration measuring apparatus according to an embodiment of the present disclosure.

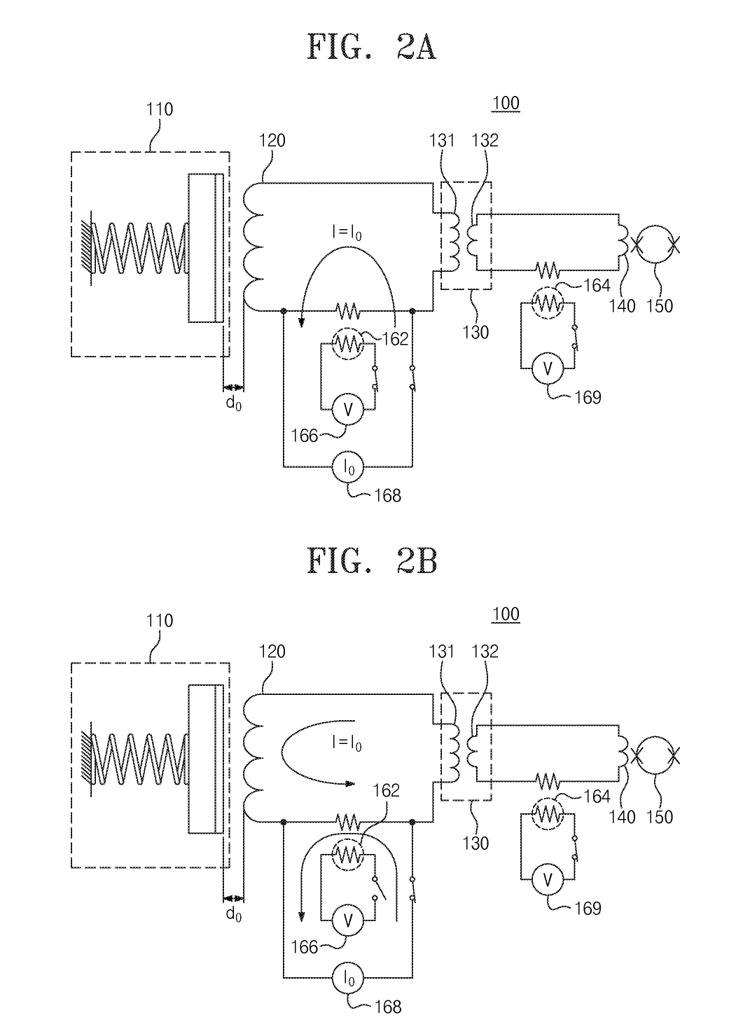

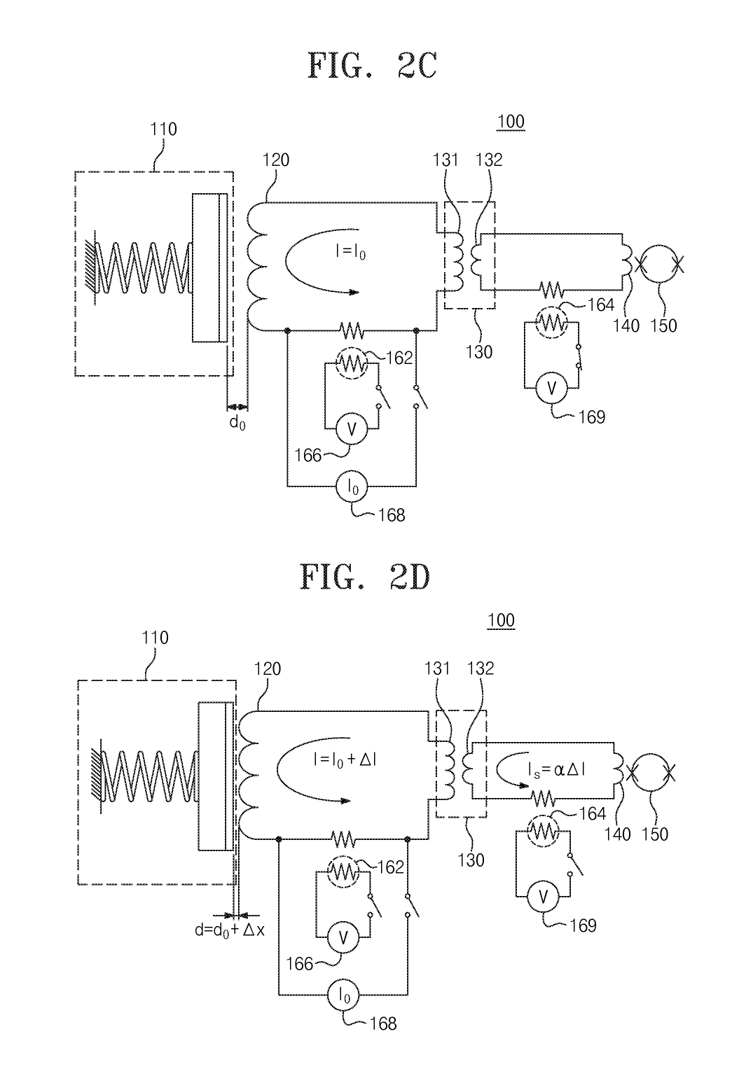

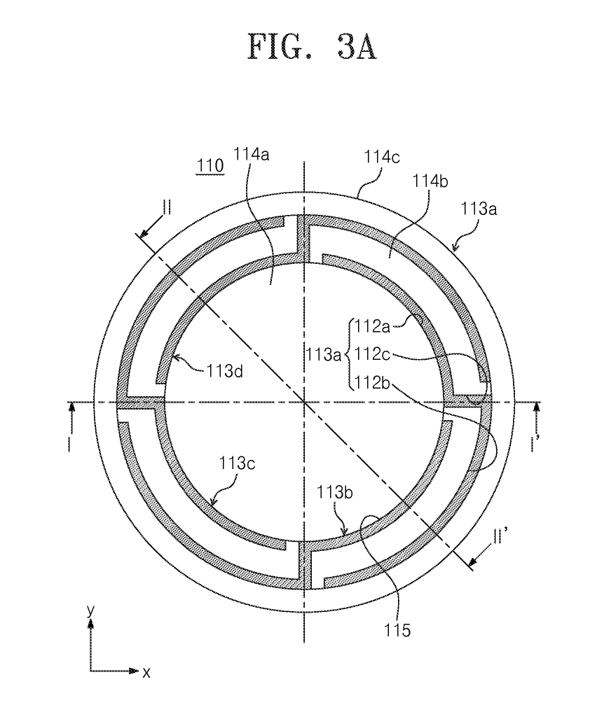

FIGS. 2A through 2D are circuit diagrams illustrating operation of an acceleration measuring apparatus according to an embodiment of the present disclosure.

Referring to FIG. 1 and FIGS. 2A through 2D, an acceleration measuring apparatus 100 includes a test mass structure 110 with a superconducting thin film 111 on its one surface and providing elasticity, a superconducting coil for measurement 120 disposed opposite to the one surface of the test mass structure 110 and magnetically coupled to the test mass structure 110, a transformer 130 disposed on the substrate and including a primary superconducting coil 131 connected to the superconducting coil 120 and a secondary superconducting coil 132 magnetically coupled to the primary superconducting coil 131, an input coil 140 disposed on the substrate and connected to the secondary superconducting coil 132, and a SQUID 150 disposed on the substrate and magnetically coupled to the input coil 140.

The test mass structure 110 may include a test mass 114a with a superconducting thin film 111 on its bottom surface and a membrane spring providing elasticity to the test mass and may be formed in one body. The superconducting thin film 111 may be a film of niobium (Nb). The test mass may be formed of an insulator or a semiconductor.

The test mass 114a may rectilinearly move according to acceleration. Thus, a distance “d” between the fixed superconducting coil 120 and the test mass 114a may vary. The superconducting thin film 111 may be disposed on a bottom surface of the test mass 114a to provide diamagnetism which repels a magnetic field established by current flowing to the superconducting coil 120. Accordingly, the superconducting thin film 111 may receive a repelling force caused by the Meissner effect from the superconducting coil 120.

The superconducting coil 120 may be made of a superconductor. The superconductor coil 120 may be a thin-film pancake coil. The superconducting coil 120 may be niobium (Nb). The superconducting coil 120 and the primary superconducting coil of the transformer 130 may be connected to each other to form a closed loop. The superconducting coil 120 may be in a spiral form. A diameter of the superconducting coil 120 may be about 10 mm and the winding number of the superconducting coil 120 may be about 100 turns.

The transformer 130 may include a primary superconducting coil 131 and a secondary superconducting coil 132. The primary superconducting coil 131 may be connected to the superconducting coil 120 through a first superconducting interconnection. The primary superconducting coil 131 and the secondary superconducting coil 132 may be aligned with each other with an interlayer dielectric interposed therebetween. In addition, the secondary superconducting coil 132 may be connected to the input coil 140 through a second superconducting interconnection. The primary superconducting coil 131 may made of a superconductor. The secondary superconducting coil 132 may be made of a superconductor.

The input coil 140 may be magnetically coupled to the SQUID 150. The input coil 140 and the secondary superconducting coil 132 may be connected to each other to form a closed loop. The input coil 140 may be made of a superconductor. A diameter of the input coil 140 may be between about 2 mm and about 3 mm. The winding number of the input coil 140 may be about 15 turns. The input coil 140 may be in a spiral form.

The SQUID 150 may be magnetically coupled to the input coil 140. The SQUID 150 may be a DC SQUID or an RF SQUID. The SQUID 150 may include a Josephson junction which may include a first superconducting layer, an insulating layer, and a second superconducting flayer stacked in order named

A first heat switch 162 is disposed on the first superconducting interconnection connecting the superconducting coil 120 to the primary superconducting coil 131. A second heat switch 164 is disposed on the second superconducting interconnection connecting the secondary superconducting coil 132 to the input coil 140. The first heat switch 162 may include a resistor. The resistor may be a palladium (Pd) thin film or a tungsten oxide (WOx) film. The second heat switch 164 may include a resistor.

When current is applied to the first heat switch 162 using an external power source 166, a resistor may provide heat and the first superconducting interconnection may be heated at a critical temperature or higher to have resistance. That is, if an external current source 168 is coupled between both ends of the first heat switch 162 when the first heat switch 162 is turned on, permanent current flows along a superconducting line having resistance of zero. To put it another way, the permanent current flows along the current source 168, the superconducting coil 120, and the primary superconducting coil 131.

When the first heat switch is turned off, the resistor stops providing heat. Thus, the first superconducting interconnection is cooled to return to a superconducting state. Thus, the superconducting coil 120 and the primary superconducting coil 131 form a superconducting closed circuit. For this reason, the current flowing to the superconducting coil 120 turns into permanent current flowing to the superconducting closed circuit. On the other hand, current generated by the external current source 168 flows through a superconducting interconnection whose resistance changes to zero. That is, when the first heat switch 162 is turned off, the superconducting circuit remains in a state of allowing superconducting permanent current to flow although the external current source 158 is removed.

When current is applied to the second heat switch 164 using an external power source 169, the second heat switch 164 is turned on. In this case, a resistor provides heat and heats the second superconducting interconnection. Accordingly, the secondary superconducting coil 132 and the input coil 140 do not form a superconducting closed circuit. For this reason, superconducting permanent current flowing to a superconducting closed circuit is not generated. In the turned-on state of the second heat switch 164, a closed circuit including a secondary superconducting coil of a transformer and an input coil has resistance. Thus, a signal generated by superconducting combination is not transmitted to the SQUID 150. That is, the resistance serves to protect the SQUID 150 from overcurrent generated from the superconducting coil 120.

While the second heat switch 164 is turned off, the secondary superconducting coil 132 and the input coil 140 form a superconducting closed coil. Variation of current flowing to the superconducting coil 120 is transferred to the input coil 140 through the transformer 130. Thus, input current flows to the input coil 140. The SQUID 150 may sense flux variation caused by the input current to output a voltage signal. While the second heat switch 164 is turned off, a test mass senses gravity (acceleration), variation of the acceleration results in small displacement, and the small displacement varies inductance. Accordingly, superconducting permanent current varies to preserve magnetic energy. As a result, the SQUID 150 may detect variation of the superconducting permanent current to output a voltage signal.

When the first heat switch 162 is turned off, a superconducting closed circuit remains in a state of allowing superconducting permanent current to flow although the external current source 168 is removed. Permanent current injected by the external power source 168 provides a repelling force to the test mass structure 110. Thus, the test mass 114a may be disposed at a starting point due to gravity generated by its weight and a diamagnetic repelling force acting in a direction opposite to that of the gravity.

When equilibrium of force is maintained while a spring is stretched, a spring gravimeter generates an error caused by nonlinearity. Thus, the superconducting thin film 111 is disposed on a bottom surface of the test mass 114a to maintain the equilibrium of force while the spring is not stretched. The superconducting thin film 111 generates a repelling force by diamagnetism against the permanent current. Thus, the test mass 114a may perform an initial operation while being unstretched.

Although the external current source 168 is removed, predetermined current permanently flows to the superconducting closed circuit. The permanently flowing current is called “superconducting permanent current”. The superconducting closed circuit stores magnetic energy U, and the magnetic energy U is preserved.

U=½LI₀² [Math Figure 1]

In the equation (1), I0 represents superconducting permanent current flowing to the superconducting closed circuit and L represents inductance of the superconducting coil for measurement 120. The inductance L may be given as below.

L=μ₀n²AdD/(d+D) [Math Figure 2]

In the equation (2), μ0 represents the permeability of the vacuum, n represents the number of windings per unit length of the superconducting coil for measurement 120, A represents an area of the superconducting coil 120, d represents a distance between the superconducting coil 120 and the superconducting thin film 111 disposed on a bottom surface of the test mass 114a, and D represents a distance between the superconducting coil 120 and a back surface superconducting thin film disposed on a back surface of a substrate on which the superconducting coil 120 is disposed.

The inductance is in proportion to a distance between the superconducting thin film 111 of the test mass 11a and the superconducting coil 120. Variation of the distance d leads to variation of the inductance L. Since the magnetic energy is preserved, the variation of the inductance L leads to variation of the superconducting permanent current flowing to the superconducting coil 120.

An output of the SQUID 150 may be connected to a signal processing unit. The signal processing unit may be disposed at a non-cooled exterior.

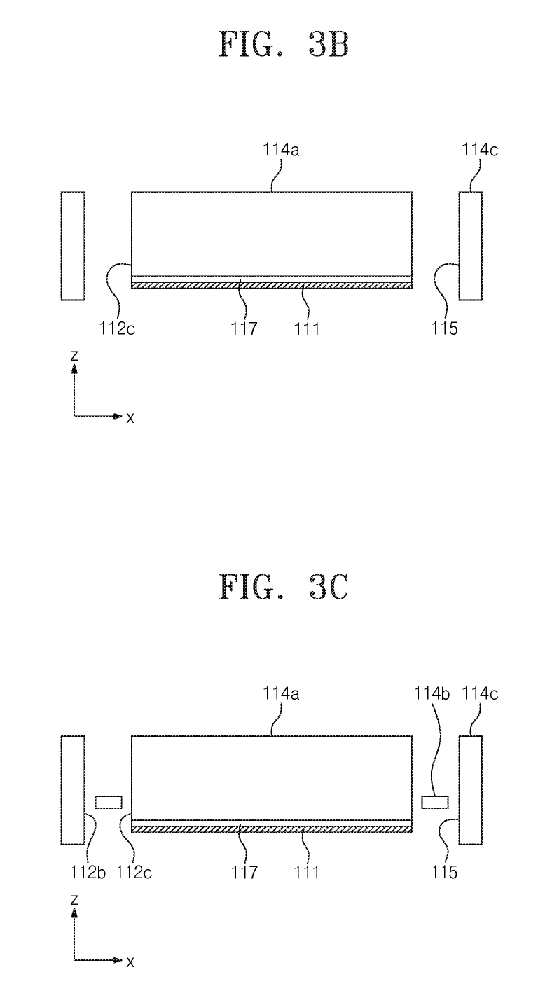

FIG. 3A is a top plan view of a test mass structure according to an embodiment of the present disclosure.

FIG. 3B is a cross-sectional view taken along the line I-I′ in FIG. 3A.

FIG. 3C is a cross-sectional view taken along the line II-II′ in FIG. 3A.

Referring to FIGS. 3A through 3C, a test mass structure 110 may include one or more slits 113a to 113d as it proceeds radially from its central axis. The slit 113a may have constant width, and an angle between a start point of the slit 113a and an end point of the slit 113a may be 90 degrees or greater on the basis of the center of the test mass structure 110.

The test mass structure 110 may be in the form of a disc and include the slits 113a to 113d formed in an azimuthal direction. The slits 113a to 113d may penetrate the test mass structure 110. A diameter of the test mass structure 110 may be between several millimeters and several centimeters.

The test mass structure 110 may include first to fourth slits 113a to 113d disposed by 90-degree rotation with respect to each other. The first slit 113a may be disposed in a first quadrant and a second quadrant, and the second slit 113b may be disposed in the second quadrant and a third quadrant. The third slit 113c may be disposed in the third quadrant and a fourth quadrant, and the fourth slit 113d may be disposed in the fourth quadrant and the first quadrant.

The first slit 113a includes a first branch 112a having a first radius and extending in an azimuthal direction in the first quadrant, a second branch 112b having a second radius greater than the first radius and extending in the azimuthal direction in the second quadrant, and a linear branch 112c extending in a radius direction to connect one end of the first branch 112a to one end of the second branch 112b.

The test mass structure 110 may include a test mass 114a disposed at the inner side of the slits 113a to 113d, a support 114c disposed at the outer side of the slits 113a to 113d, and a membrane spring 114b between an inner side region and an outer side region. Thickness of the membrane spring 114b may be smaller than thickness of the test mass 114a and thickness of the support 114c. The superconducting thin film 111 may be disposed on a bottom surface of the test mass 114a. A bottom surface of the test mass 114a may include a dent portion 115. Alternatively, a bottom surface of the support 114c may be protrusive. Accordingly, there may be provided a space in which the test mass 114a is movable.

An insulating layer 117 may be disposed between the superconducting thin film 111 and the test mass 114a. The test mass 117 may be silicon. The superconducting thin film 111 may be made of niobium (Nb).

The membrane spring may be stretched in the Z-axis direction by gravity of the test mass 114a. A structure of the membrane spring may be variously modified.

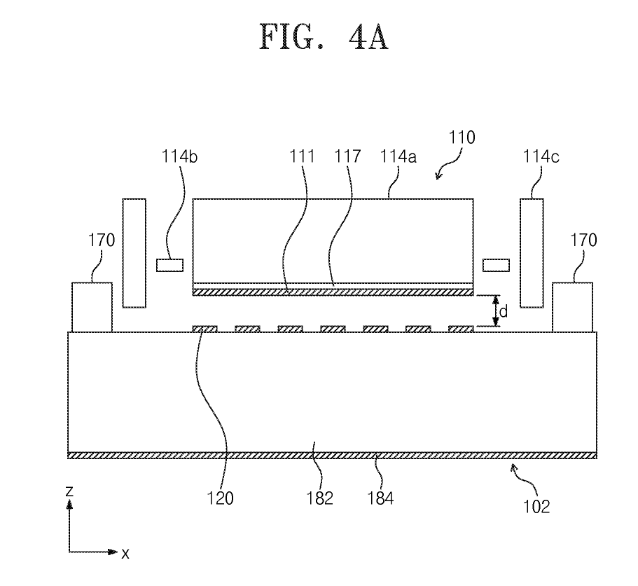

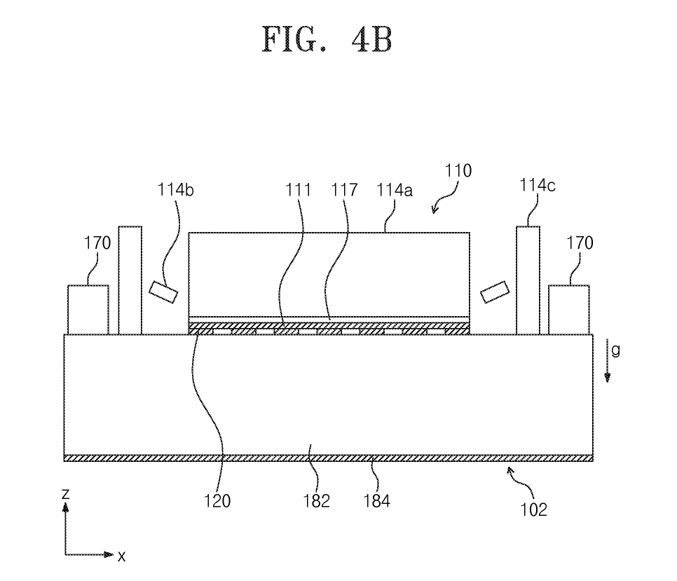

FIGS. 4A and 4B are cross-sectional views of a superconducting acceleration measuring apparatus according to an embodiment of the present disclosure.

Referring to FIGS. 4A and 4B, an acceleration measuring apparatus may include a test mass structure 110 and a SQUID sensor module 102. The test mass structure 110 and the SQUID sensor module 102 may be combined with each other after being fabricated using separate components.

The test mass structure 110 may include a test mass 114a with a superconducting thin film 111 on its bottom surface and a membrane spring 114 providing elasticity to the test mass 114a and may be formed in one body. The test mass structure 110 may include a test mass 114a disposed at the inner side of a slit, a support 114c disposed at the outer side of the slit, and a membrane spring 114b between an inner side region and an outer side region. Thickness of the membrane spring 114b may be smaller than thickness of the test mass 114a and thickness of the support 114c, and the superconducting thin film 111 may be disposed on the bottom surface of the test mass 114a. The bottom surface of the test mass 114a may be dented. Alternatively, a bottom surface of the support 114c may be protrusive. An insulating layer 117 may be disposed between the superconducting thin film 111 and the test mass 114a. The test mass structure 110 may be silicon. The superconducting thin film 111 may be made of niobium (Nb).

The SQUID sensor module 102 may include a superconducting coil for measurement 120, a transformer, an input coil, and a SQUID. The SQUID sensor module 120 may measure variation of permanent current depending on displacement between the test mass 114a and the superconducting coil 120. A back surface superconducting thin film 184 may be disposed below the superconducting coil 120. The superconducting coil 120, the transformer, the input coil, and the SQUID may be integrated into a substrate 182 using a semiconductor process.

A guide ruing 170 may be disposed around the superconducting coil 120 to align the test mass structure 110. The guide ring 170 may be mounted on the superconducting coil 120 after being manufactured separately from the superconducting coil 120. The guide ring 170 may be made of an insulator.

For example, when acceleration of gravity increases, the test mass 114a may move in the Z-axis direction. Inductance of the superconducting coil 120 may vary.

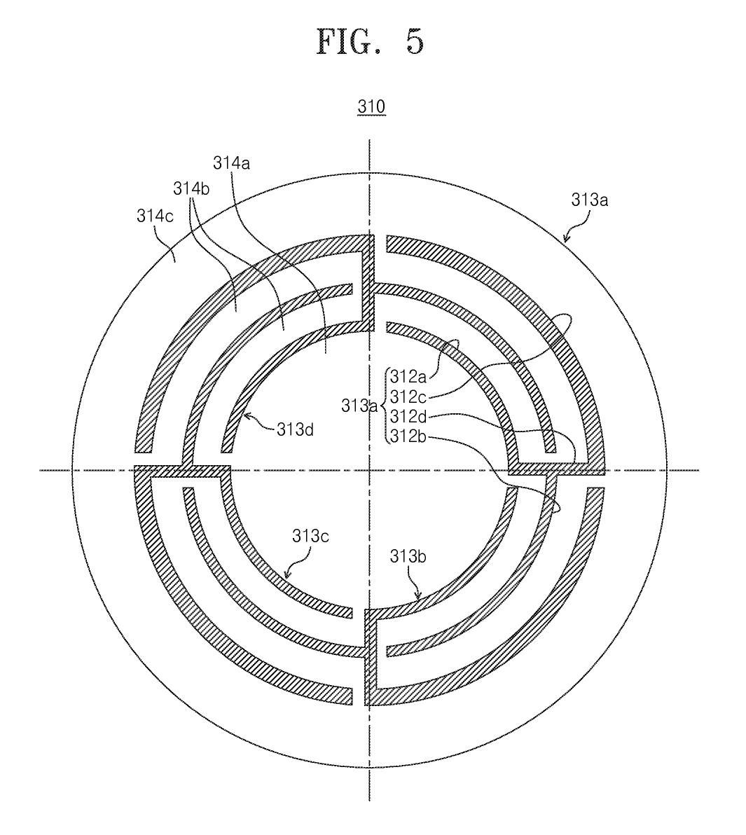

FIG. 5 is a top plan view of a test mass structure according to another embodiment of the present disclosure.

A test mass structure 310 may include first to fourth slits 313a to 313d disposed by 90-degree rotation with respect to each other. The first slit 313a includes a first branch 312a having a first radius and extending in an azimuthal direction in the first quadrant, a second branch 312b having a second radius greater than the first radius and extending in the azimuthal direction in the second quadrant, a third branch 313c having a third radius greater than the second radius and extending in the azimuthal direction in the first quadrant, and a linear branch 312d extending in a radial direction to connect one end of the first branch 312a, one end of the second branch 312b, and one end of the third branch 312c to each other.

The test mass structure 310 may include a test mass 314a disposed at the inner side of the slits 313a to 313d, a support 314c disposed at the outer side of the slits 313a to 313d, and a membrane spring 314b between the test mass 314a and the support 314c.

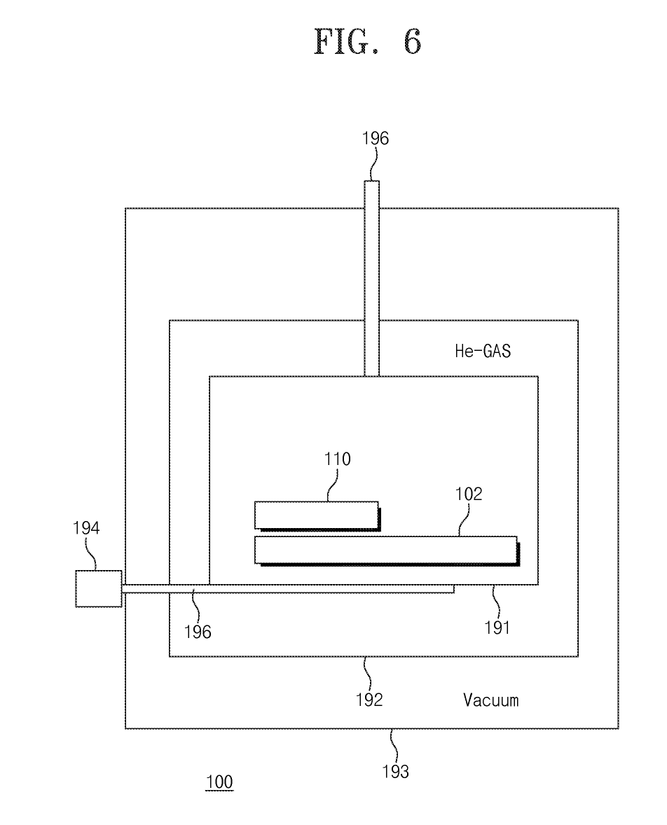

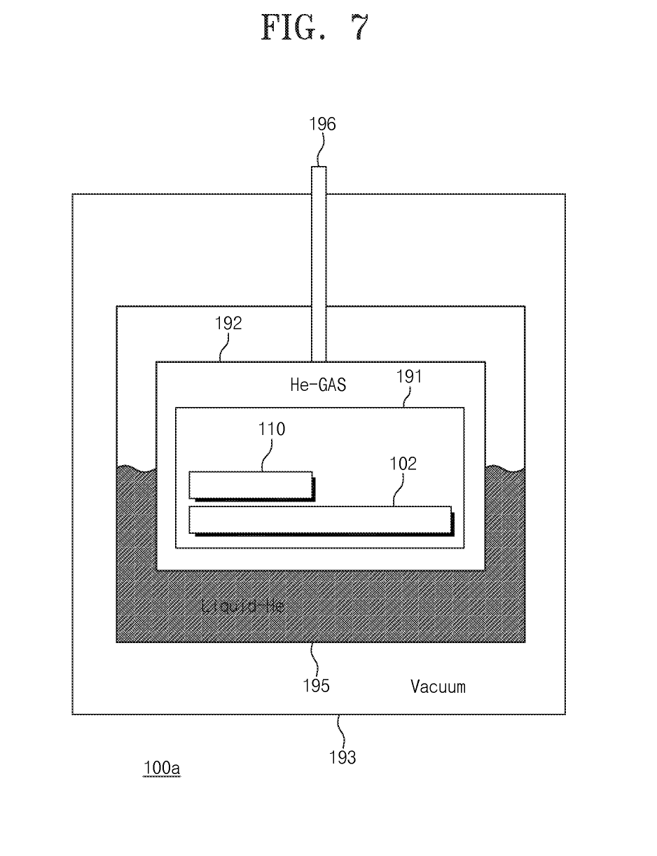

FIGS. 6 and 7 illustrate acceleration measuring apparatuses according to embodiments of the present disclosure, respectively.

Referring to FIG. 6, an acceleration measuring apparatus 100 may include a test mass structure 110 including a test mass with a superconducting thin film on its bottom surface and a membrane spring providing elasticity to the test mass and being formed in one body and a SQUID sensor module 102 including a superconducting coil for measurement, a transformer, an input coil, and a SQUID and measuring variation of permanent current depending on displacement between the test mass and the superconducting coil.

A superconducting case 191 may store the test mass structure 110 and the SQUID sensor module 102. The superconducting case 191 may be made of niobium (Nb). The superconducting case 191 may be made of a superconducting material, e.g., niobium (Nb) or lead (Pb). The superconducting case 191 may shield an electromagnetic noise. Since the amount of ultrafine variation of a superconducting coil caused by gravity variation induces current variation and the amount of ultrafine current variation is measured, it is necessary to block a disturbance signal from an external entity. Since a magnetic field within a superconductor must be zero, shielding may be achieved by completely covering the superconductor with a superconducting material.

A vacuum can 192 may store the superconducting case 191. After being exhausted, the vacuum can 192 may be filled with a helium gas. The vacuum can 192 may be made of a superconductor. An outer container 193 may store the vacuum can 192, and the inside of the outer container 193 may be maintained in a vacuum state. A space between the outer container 193 and the vacuum can 192 may be in a vacuum state and may block heat transfer.

A heat transfer medium 196 may thermally contact the superconducting case 191 to cool the same. The heat transfer medium 196 may be a copper rod.

A cryocooler 194 may thermally contact the heat transfer medium 196 and may be disposed outside the outer container 193.

Referring to FIG. 7, an acceleration measuring apparatus 100a may include a test mass structure 110 and a SQUID sensor module 102. The test mass structure 110 includes a test mass with a superconducting thin film on its bottom surface and a membrane spring providing elasticity to the test mass and may be formed in one body. The SQUID sensor module 102 may include a superconducting coil for measurement, a transformer, an input coil, and a SQUID and may measure variation of permanent current depending on displacement between the test mass and the superconducting coil for measurement.

A superconducting case 191 may store the test mass structure 110 and the SQUID sensor module 102. A material of the superconducting case 191 may be niobium (Nb). The superconducting case 191 may comprise a superconducting material.

A vacuum can 192 may receive the superconducting case 191 and may be filled with a helium gas after being exhausted. The vacuum can 191 may be made of a superconductor. The vacuum can 191 may comprise a superconducting material.

An inner container 195 may receive the vacuum can 192 and may be filled with a coolant such as liquid helium.

An outer container 193 may receive the inner container 195, and a space between the inner container 193 and the outer container 195 may be maintained in a vacuum state.

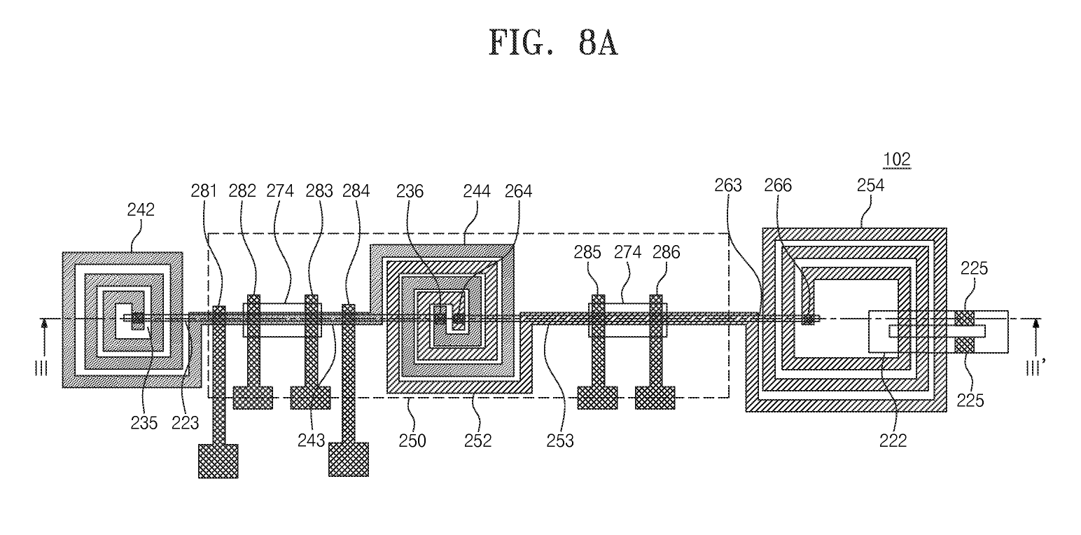

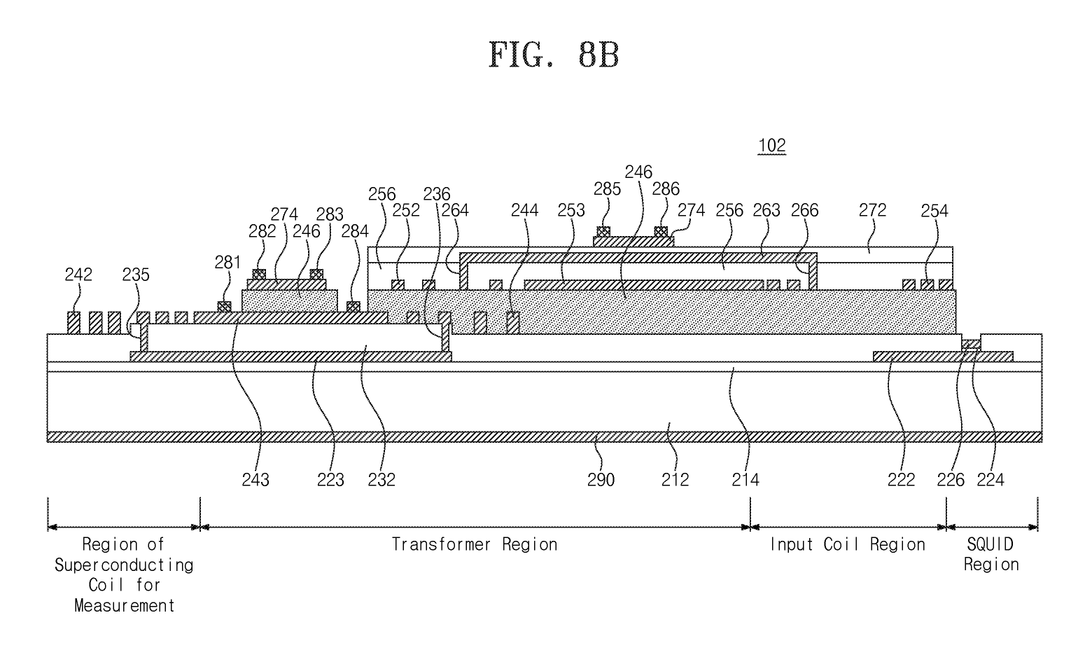

FIG. 8A is a top plan view of a SQUID sensor module according to an embodiment of the present disclosure.

FIG. 8B is a cross-sectional view taken along the line III-III′ in FIG. 8A.

Referring to FIGS. 8A and 8B, a SQUID sensor module 102 includes a superconducting coil for measurement 242, a transformer 250, an input coil 254, and a SQUID 225.

The superconducting coil 242 is disposed on a substrate 212 and magnetically coupled to an external measurement target (not shown). The transformer 250 is disposed on the substrate 212 and includes a primary superconducting coil 244 connected to the superconducting coil 242 and a secondary superconducting coil 252 magnetically coupled to the primary superconducting coil 244. The input coil 254 is disposed on the substrate 212 and connected to the secondary superconducting coil 252. The SQUID 225 is disposed on the substrate 212 and magnetically coupled to the input coil 254.

The substrate 212 may include a region of superconducting coil for measurement, a transformer region, an input coil region, and a SQUID region. A first interconnection 223 may be disposed on the substrate 212 to connect the superconducting coil 242 and the primary superconducting coil 244 to each other through vias 235 and 236.

The input coil region and the SQUID region may overlap each other through a washer 222. The transformer region may include a primary superconducting coil region, a secondary superconducting region overlapping the primary superconducting coil region, a second interconnection region to electrically connect a primary superconducting coil and a superconducting coil for measurement to each other, and a third interconnection region to electrically connect the secondary superconducting coil and an input coil to each other.

A lower insulating layer 214 may be disposed on the substrate 212. The lower insulating layer 214 may be a layer of silicon oxide or silicon nitride. The substrate 212 may be a silicon single-crystal substrate or a sapphire substrate.

The SQUID may include a pair of Josephson junctions and a washer 222. The SQUID 225 may include a washer 222 to form a closed loop and a pair of

Josephson junctions formed on the washer 222. The Josephson junction may have a structure including a first superconducting layer, an insulating layer, and a second superconducting layer stacked in the order named The first superconducting layer of the Josephson junction may be continuously connected to the washer 222.

A first interconnection 223 may be disposed on the same plane as the first superconducting layer. The interconnection 223 may connect the superconducting coil 242 and the primary superconducting coil 244 to each other through vias 235 and 236. The first interconnection 223 and the Josephson junction may be formed at the same time by an etch process. The first interconnection 223 may be a superconductor.

A first interlayer dielectric 232 may be disposed on the first interconnection 223. The first interlayer dielectric 232 may be a layer of silicon oxide. The first interlayer dielectric 232 may be disposed on the washer 222.

The vias 235 and 236 are formed to penetrate the first interlayer dielectric 232. The via 236 may be disposed in the center of the primary superconducting coil 244, and the via 235 may be disposed in the center of the superconducting coil 242. The vias 235 and 236 may be connected to each other the first interconnection 223 below the first interlayer dielectric 232. Each of the vias 235 and 236 may be a superconductor. A top surface of the first interlayer dielectric 232 may have a step caused by the first interconnection 223, but thickness of the first interconnection 223 may several micrometers or less, i.e., the surface of the first interconnection 223 may be substantially flat.

The superconducting coil 242 may be made of a superconductor. The superconductor coil 242 may be disposed on the first interlayer dielectric 232. The superconducting coil 242 may be about 100 turns, and a diameter of the superconducting coil 242 may be about several millimeters. The superconducting coil 242 may be a pancake coil. Preferably, the superconducting coil 242 may have a spiral shape on the same plane.

The primary superconducting coil 244 may be made of a superconductor. The primary superconducting coil 244 may be disposed on the first interlayer dielectric 232. The primary superconducting coil 244 may be about tens of turns.

A second interconnection may be disposed on the first interlayer dielectric 232 to connect the superconducting coil 242 and the primary superconducting coil 244 to each other. The second interconnection may be a superconductor.

A second interlayer dielectric 246 may be disposed on the first interlayer dielectric 232 and the primary superconducting coil 244. The second interlayer dielectric 246 may not be disposed on the superconducting coil 242. In addition, the second interlayer dielectric 246 may not be disposed on the Josephson function.

The second interlayer dielectric 246 may be disposed on a portion of the second interconnection 243. Thus, a first resistance pattern 274 constituting a first heat switch may be disposed on the second interlayer dielectric 246 on the second interconnection 243. The first resistance pattern 274 may be palladium (Pd) or tungsten oxide (WOx). The second interlayer dielectric 246 may be a layer of silicon oxide.

First heat switch pad 282 and 283 may be disposed on the first resistance pattern 274. Each of the first heat switch pads 282 and 283 may be gold (Au). When an external power source is connected through the first heat switch pads 282 and 283, the first resistance pattern 274 may provide heat.

The second interlayer dielectric 246 may not be disposed at a portion of the second interconnection disposed at both sides of a first heat switch. Permanent current injection pads 281 and 284 may be disposed at both sides of the second interconnection 243. Each of the permanent injection pads 281 and 284 may be gold (Au).

When an external current source is connected through the permanent current injection pads 281 and 284, the external current source may inject permanent current into the superconducting coil 242 and the primary superconducting coil 244.

A second interlayer dielectric 246 may be disposed on the primary superconducting coil 244. Thus, the secondary superconducting coil 252 aligned with the primary superconducting coil 244 may be disposed on the second interlayer dielectric 246. The winding number of the secondary superconducting coil 252 may be equal to that of the primary superconducting coil 244. The secondary superconducting coil 252 may be niobium (Nb).

An input coil 254 may be disposed on the second interlayer dielectric 246. A third interconnection 253 may be disposed on the second interlayer dielectric 246 to connect the input coil 254 and the secondary superconducting coil 252 to each other. The third interconnection 253 may be a superconductor.

The input coil 254 may be made of a superconductor and disposed on the second interlayer dielectric 246. A washer 222 may be disposed in a radial direction of the input coil 254.

A third interlayer dielectric 256 may be disposed on the secondary superconducting coil 252, the third interconnection 253, and the input coil 254. The third interlayer dielectric 256 may be a layer of silicon oxide. Vias 264 and 266 may be formed to penetrate the third interlayer dielectric 256. The via 264 may be connected to the center of the secondary superconducting coil 252, and the via 266 may be connected to the center of the input coil 254.

A fourth interconnection 263 may be disposed on the third interlayer dielectric 256. The fourth interconnection 263 may connect the vias 264 and 266 to each other. The fourth interconnection 263 may be a superconductor. In addition, each of the vias 264 and 266 may be a superconductor.

A fourth interlayer dielectric 272 may be disposed on the fourth interconnection 263. The fourth interlayer dielectric 272 may be a layer of silicon oxide. The third interlayer dielectric 256 may be aligned with the fourth interlayer dielectric 272.

A second resistance pattern 274 may be disposed on the fourth interlayer dielectric 272. The second resistance pattern 274 may be palladium (Pd) or tungsten oxide (WOx).

A pair of second heat switch pads 285 and 286 may be connected onto the second resistance pattern 274. Each of the second heat switch pads 285 and 286 may be gold (Au).

A back surface superconducting thin film 290 may be disposed on a back surface or a bottom surface of the substrate 212.

A fabrication method of a SQUID sensor may include forming a SQUID 225 on a substrate 212, forming a superconducting coil for measurement 242 on the substrate 212, the superconducting coil for measurement 242 being spaced apart from the SQUID 225 and formed of a superconductor, forming a primary superconducting coil 244 of a transformer disposed on the substrate 212 and connected to the superconducting coil for measurement 242, forming a secondary superconducting coil 252 of the transformer magnetically coupled to the primary superconducting coil 244, and forming an input coil 254 magnetically coupled to the SQUID 225, disposed on the substrate 212, and connected to the secondary superconducting coil 252 of the transformer. A superconducting thin film, an interlayer dielectric, a resistance pattern, a heat switch pad, and a permanent injection pad may be formed by a lift-off process. In addition, a Josephson junction, a superconducting coil for measurement, a transformer, an input coil, and an interconnection may be formed by an etch process using a photoresist as an etch mask.

Hereinafter, a method for manufacturing a SQUID sensor module will now be described below in detail.

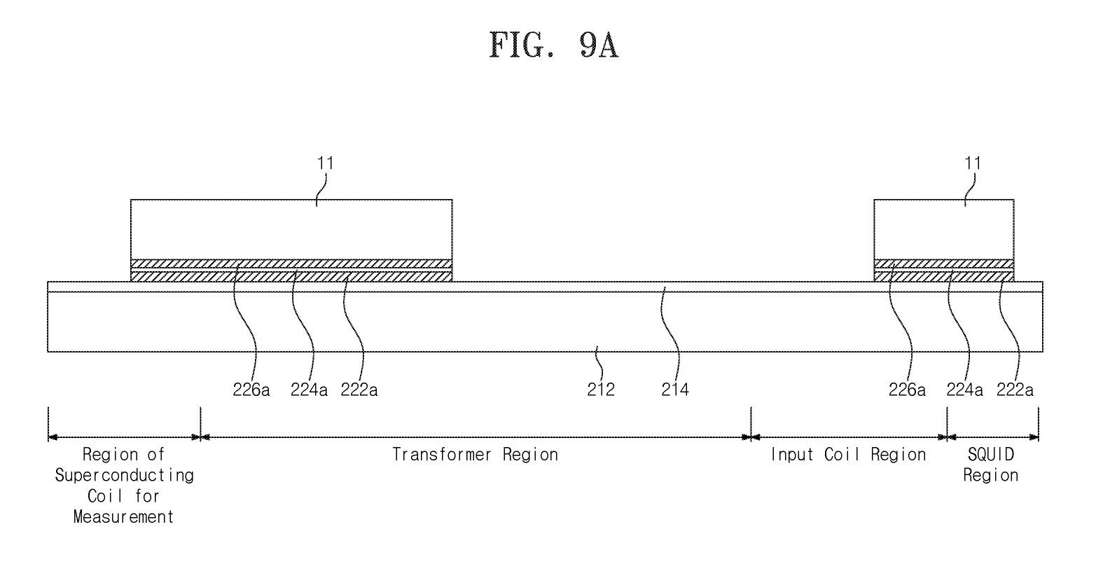

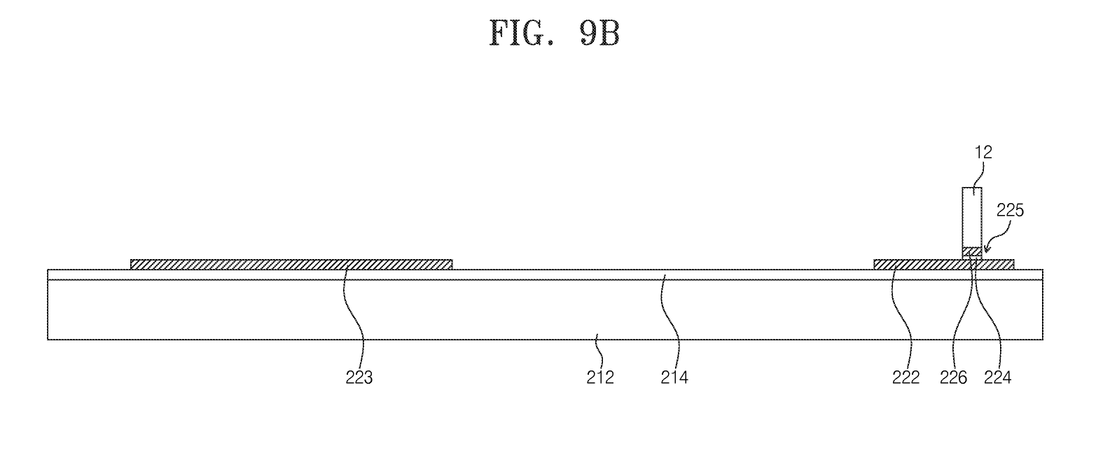

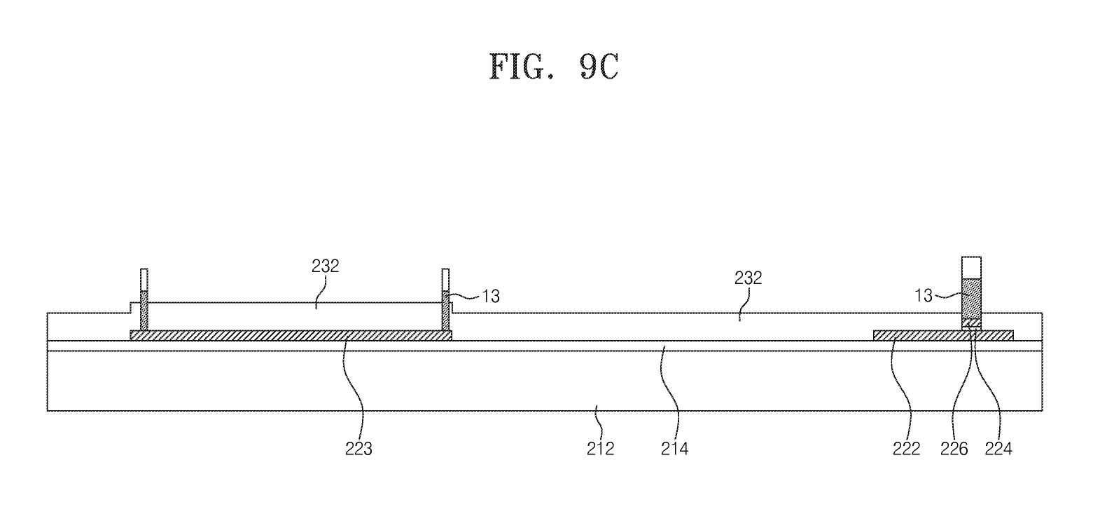

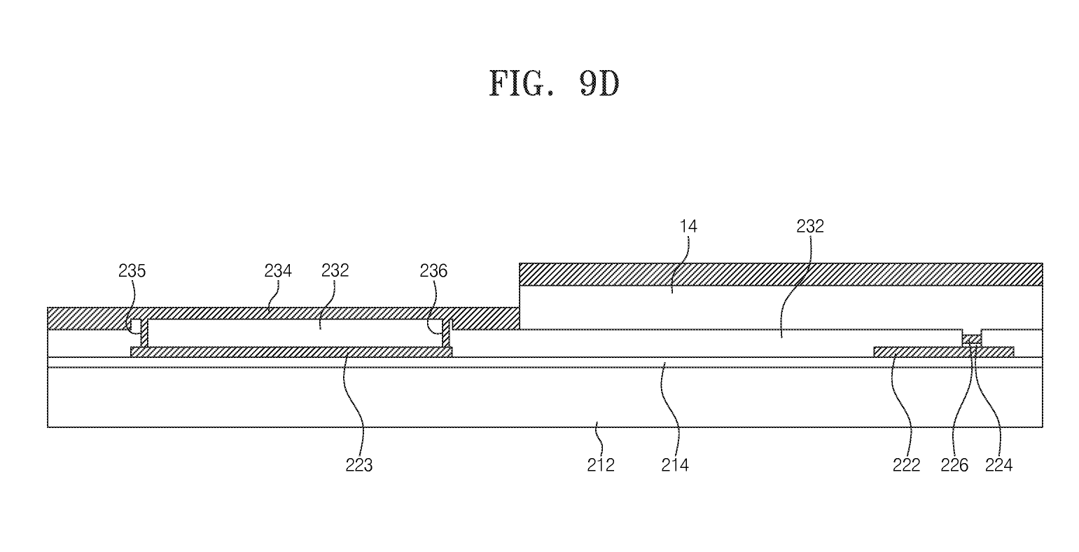

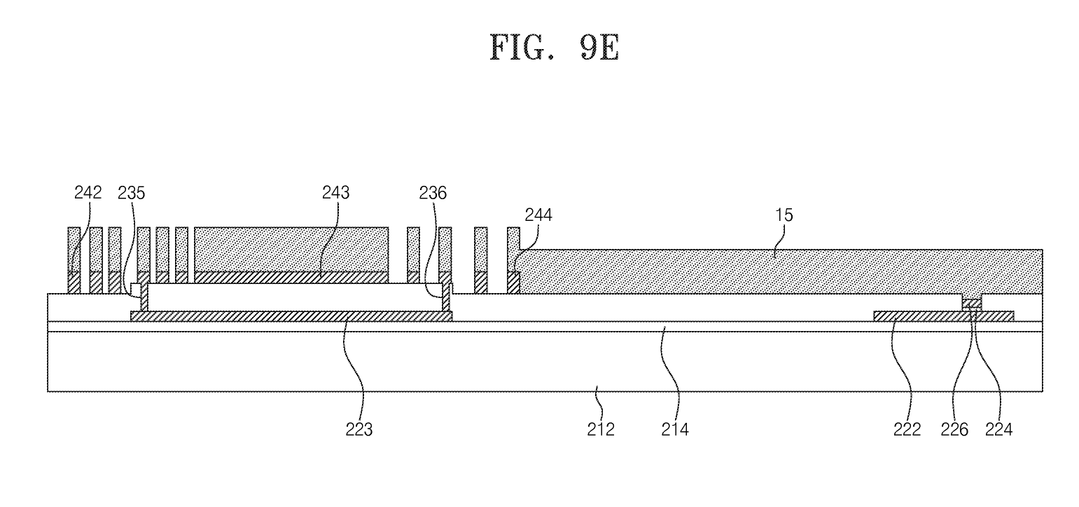

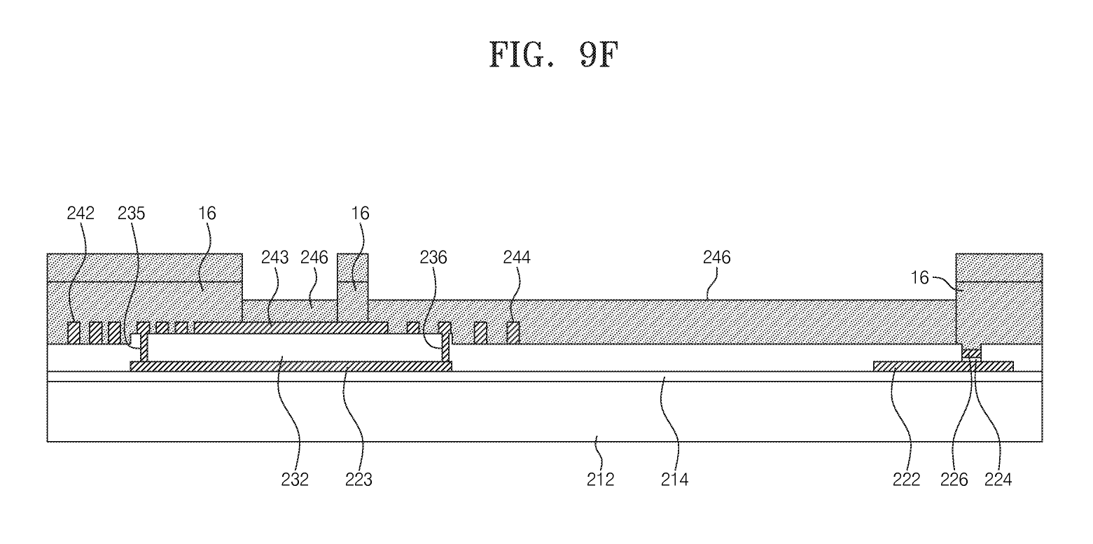

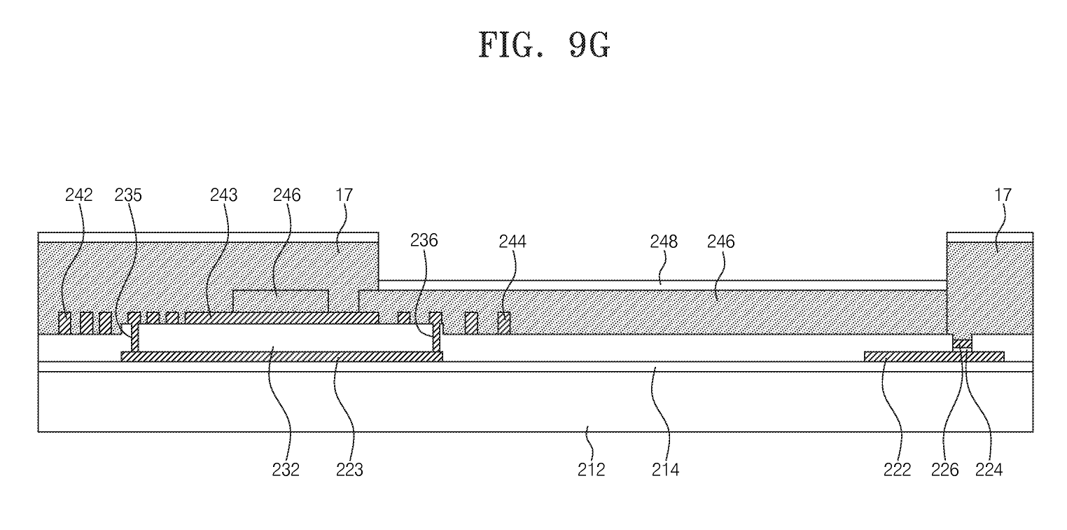

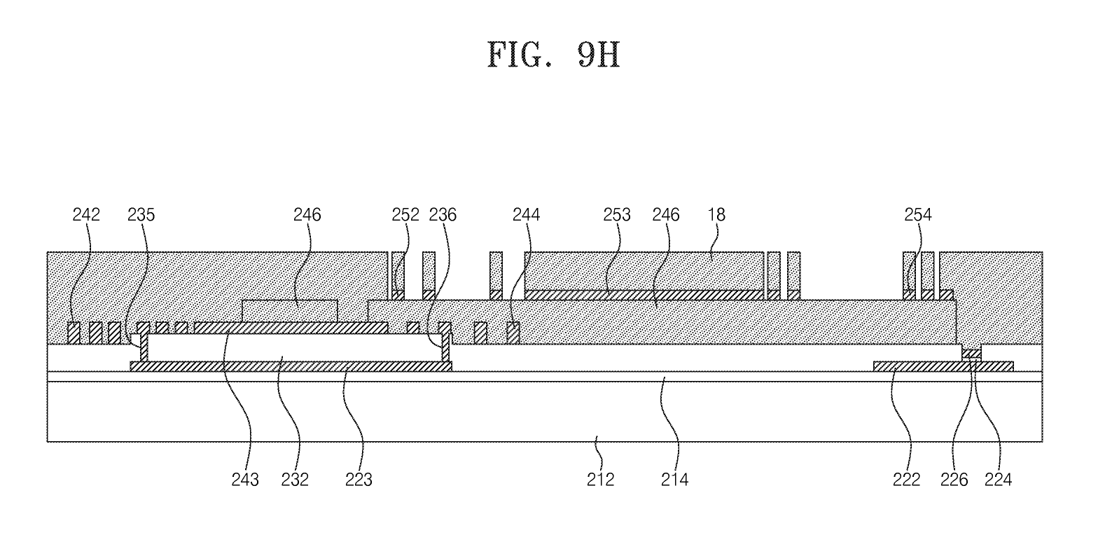

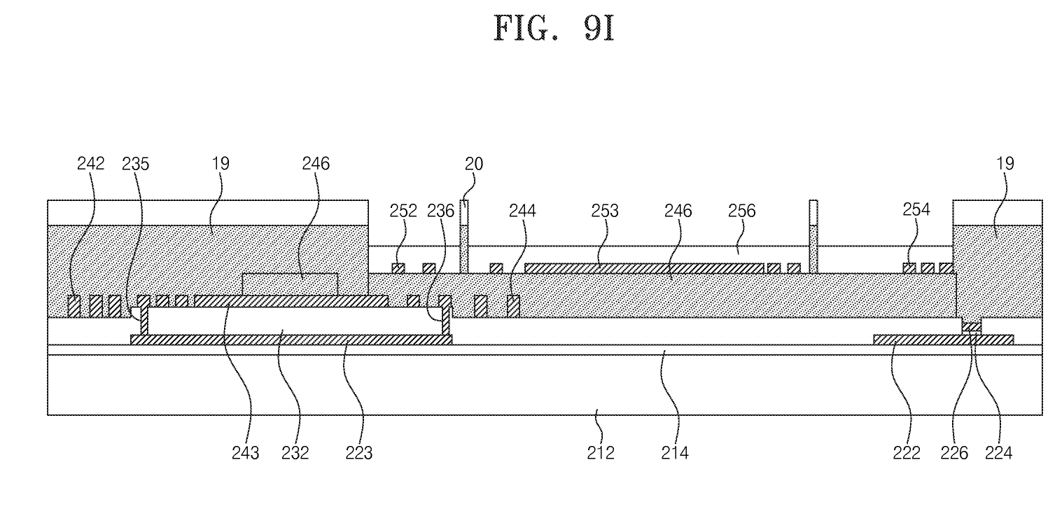

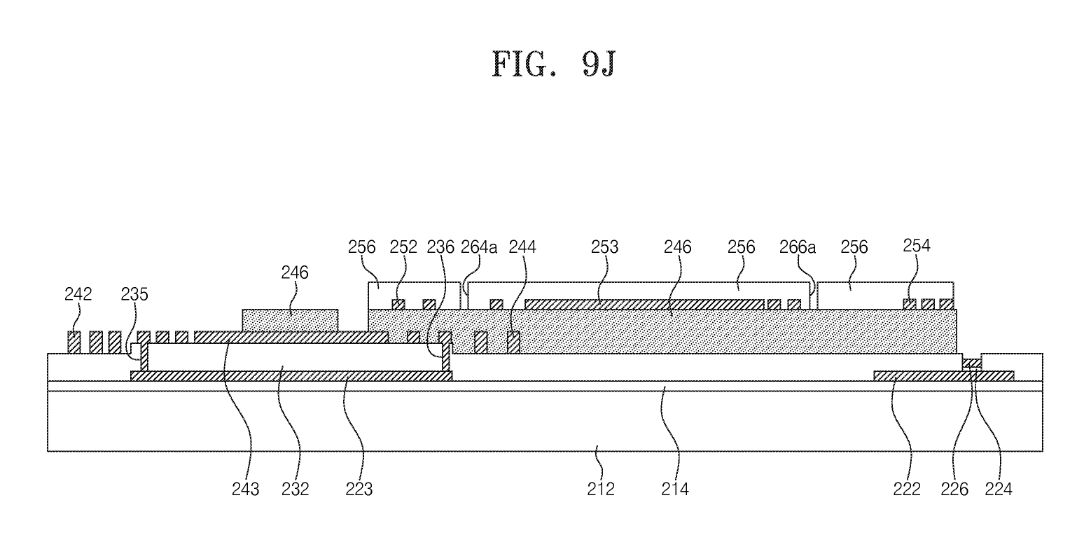

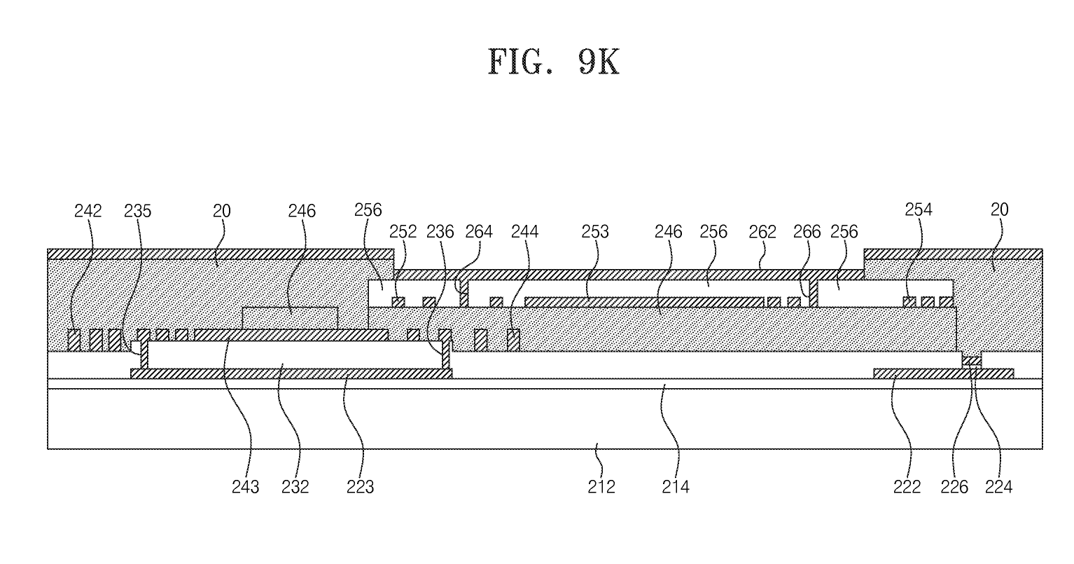

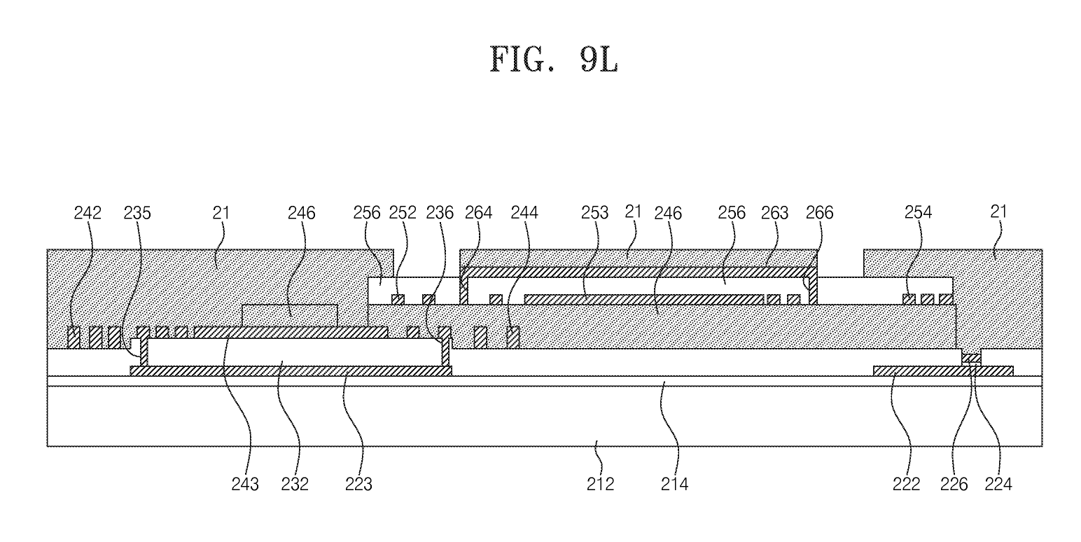

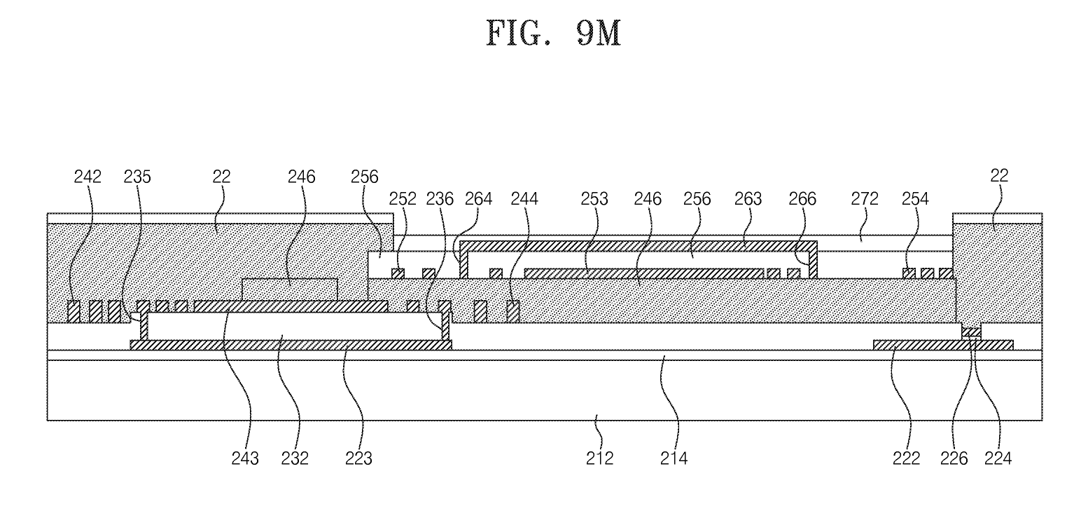

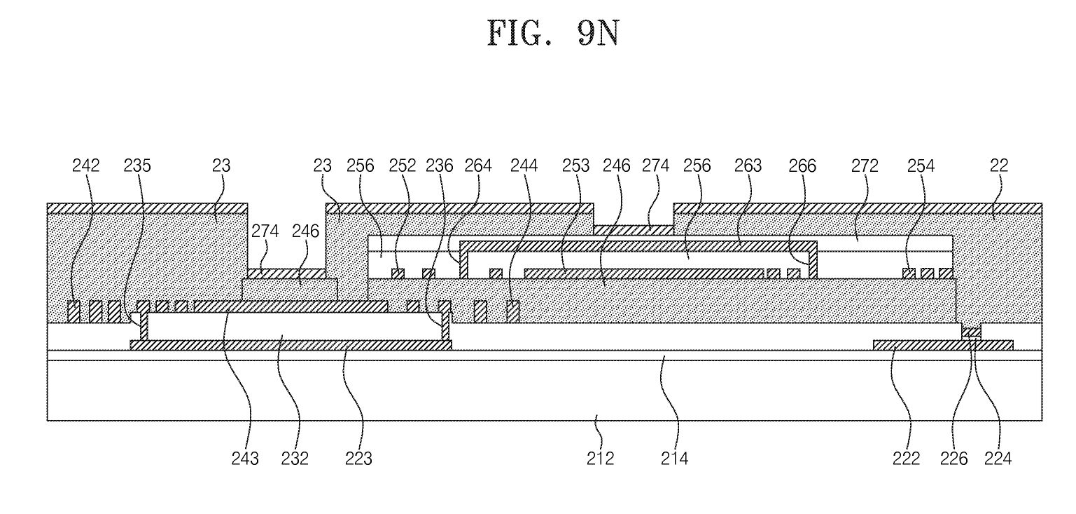

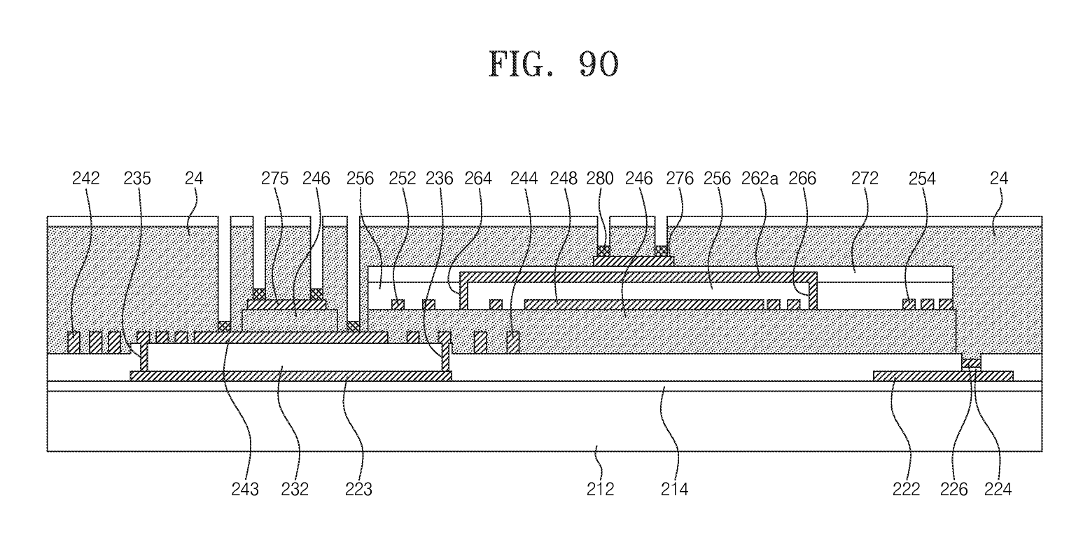

FIGS. 9A through 9O are cross-sectional views illustrating a method for manufacturing the SQUID sensor module shown in FIG. 8A.

Referring to FIG. 9A, a SQUID is formed on a substrate 212. Specifically, the substrate 212 may be a silicon single-crystal substrate or a sapphire substrate. A lower insulating layer 214 is formed on the substrate 212. The lower insulating layer 214 may be a layer of silicon oxide. A first superconducting layer, an insulating layer, and a second superconducting layer may be sequentially deposited on the substrate 212 where the lower insulating layer 214 is formed. The first superconducting flayer is formed of niobium (Nb), and the insulating layer may be formed of aluminum oxide (Al2O3) or niobium oxide (Nb2O5). Thickness of the insulating layer may be several millimeters or less. Thus, the first superconducting layer, the insulating layer, and the second superconducting flayer may constitute a Josephson junction.

A photoresist pattern 11 may be formed by coating a photoresist on the substrate 212 on which the first superconducting layer, the insulating layer, and the second superconducting layer and performing a photolithography process.

The substrate 212 may be divided into a region of superconducting coil for measurement in which a superconducting coil for measurement is disposed, a transformer region in which a transformer is disposed, an input coil region in which an input coil is disposed, and a SQUID region in which a SQUID is disposed. The SQUID region may be a region in which a Josephson junction is disposed. The Josephson junction may be magnetically coupled to the input coil through a washer. The washer may be in the form of a rectangle, and the input coil and the washer may have an overlap region.

The photoresist pattern 11 may be disposed on the SQUID region and the washer 222. The photoresist pattern 11 may be disposed on a portion of a primary superconducting coil region that electrically connects the region of superconducting coil for measurement to the primary superconducting coil of the transformer. That is, the photoresist pattern 11 may expose some of the rest of the primary superconducting coil region, a secondary superconducting coil region, and the input coil region.

The second superconducting layer, the insulating layer, and the first superconducting layer may be successively etched using the photoresist pattern 11 as an etch mask to form a second superconducting preliminary pattern 226a, a preliminary insulating pattern 224a, and a first superconducting preliminary pattern 222a on the region of superconducting coil for measurement. In addition, the second superconducting layer, the insulating layer, and the first superconducting layer may be successively etched using the photoresist pattern 11 as an etch mask to form a second superconducting preliminary pattern 226a, a preliminary insulating pattern 224a, and a first preliminary superconducting pattern 222a on the SQUID region and a washer region. Then, the photoresist pattern 11 may be removed.

Referring to FIG. 9B, a photoresist pattern 12 may be formed on the SQUID region. The second preliminary superconducting pattern 226a and the preliminary insulating pattern 224a may be etched using the photoresist pattern 12 as an etch mask to a pair of Josephson junction patterns 226 and 224 in the SQUID region. The first preliminary superconducting pattern 222a may form the washer 222 that forms a closed loop. The washer 222 and the Josephson junction patterns 224 and 226 may constitute a Josephson junction. In addition, a first interconnection may be formed at a portion of the region of superconducting coil for measurement and the primary superconducting coil region of the transformer. The first interconnection 223 may be formed of a superconductor. The first interconnection 223 may connect the center of the primary superconducting coil and the center of the superconducting coil for measurement to each other through a via. The photoresist pattern 12 may be removed.

Referring to FIG. 9C, a photoresist pattern 13 may be formed on the substrate 212. The photoresist pattern 212 may be formed at both ends of the first interconnection 223 and on the Josephson junction. A first interlayer dielectric 232 may be deposited on the substrate 212 where the photoresist pattern 13 is formed. Then, the photoresist pattern 13 may be removed to form a via hole at both the ends of the first interconnection 223 and to form a hole on the Josephson junction. Then, the photoresist pattern 13 may be removed.

Referring to FIG. 9D, a photoresist pattern 14 may be formed on the substrate 212 to expose the region of superconducting coil for measurement and the primary superconducting coil region. A first superconducting thin film 234 may be deposited on the substrate 212 where the photoresist pattern 14 is formed. The first superconducting thin film 234 may be formed of niobium (Nb). The first superconducting thin film 234 may fill the via hole to form vias 235 and 236.

Referring to FIG. 9E, the first superconducting thin film deposited on the photoresist pattern 14 may be removed. In addition, the photoresist pattern 14 may be removed. Another photoresist pattern 15 may be formed on the substrate 212. The photoresist pattern 14 may include a pattern in the form of the superconducting coil for measurement and a pattern in the form of a primary superconducting coil of the transformer. The first superconducting thin film 234 may be etched using the photoresist pattern 14 as an etch mask to form a superconducting coil for measurement 242, a primary superconducting coil 244 of a transformer, and a second interconnection 243 connecting the superconducting coil for measurement 242 and the primary superconducting coil 244 to each other. Then, the photoresist pattern 14 may be removed.

Referring to FIG. 9F, a photoresist pattern 16 may be formed on the substrate 212 where the second interconnection 243 is formed. The photoresist pattern 16 may expose a portion of the second interconnection 243. In addition, the photoresist pattern 16 may expose the primary superconducting coil region and the input coil region of the transformer. A second interlayer dielectric 246 may be deposited on the substrate 212 where the photoresist pattern 16 is formed. The second interlayer dielectric 246 may be disposed on a central region of the second interconnection 243, the secondary superconducting coil 244, and the input coil. Then, the photoresist pattern 16 may be removed.

Referring to FIG. 9G, another photoresist pattern 17 is formed on the substrate 212 where the second interlayer dielectric 246 is formed. The photoresist pattern 17 may expose the secondary superconducting region and the input coil region. A second superconducting thin film 248 may be deposited on the substrate 212 where the photoresist pattern 17 is formed.

Referring to FIG. 9H, the photoresist pattern 17 and the second superconducting thin film 248 deposited on the photoresist pattern 17 may be removed by a lift-off process. Thus, the second superconducting thin film 248 may be disposed on the secondary superconducting coil region and the input coil region.

Another photoresist pattern 18 may be formed on the substrate 212. The photoresist pattern 18 may be in the form of the secondary superconducting coil and the input coil of the transformer. The second superconducting thin film 248 may be etched using the photoresist pattern 18 as an etch mask to a secondary superconducting coil 252, an input coil 254, and a third interconnection 253 connecting the secondary superconducting coil 252 and the input coil 254 to each other. Then, the photoresist pattern 18 may be removed.

Referring to FIG. 9I, another photoresist pattern 19 may be formed on the substrate 212. The photoresist pattern 19 may expose the secondary superconducting coil region of the transformer apart from the central region of the secondary superconducting coil 252. Then, a third interlayer dielectric 256 may be deposited on the substrate 212.

Referring to FIG. 9J, the photoresist pattern 19 and the third interlayer dielectric 256 deposited on the photoresist pattern 19 may be removed to form a via hole 264a in the central region of the secondary superconducting coil 252 and form a via hole 266a in the central region of the input coil 254. The third interlayer dielectric 256 may be disposed on the secondary superconducting coil region and the input coil region.

Referring to FIG. 9K, another photoresist 20 may be formed on the substrate 212. The photoresist pattern 20 may expose the secondary superconducting coil region and the input coil region. Then, a third superconducting thin film 262 may be deposited on the substrate 212. Thus, the via holes 264a and 266a may be filled with a superconducting material to form vias 264 and 266.

Referring to FIG. 9L, the photoresist pattern 20 may be removed by a lift-off process. Another photoresist pattern 21 may be formed on the substrate 212 to achieve precise patterning. The photoresist pattern 21 may be formed to expose a portion of the third superconducting thin film 262. The third superconducting thin film 262 may be etched using the photoresist pattern 21 as an etch mask to form a fourth interconnection 263.

Referring to FIG. 9M, the photoresist pattern 21 may be removed. Another photoresist pattern 22 may be formed on the substrate 212. The photoresist pattern 22 may expose the primary superconducting coil region and the input coil region. Then, a fourth interlayer dielectric 272 may be deposited.

Referring to FIG. 9N, the photoresist pattern 22 may be removed to expose a portion of the superconducting coil 242 and a portion of the second interconnection 243. Another photoresist pattern 23 may be formed on the substrate 212. The photoresist pattern 23 may expose a portion of the second interlayer dielectric 246 disposed on the second interconnection 243. In addition, the photoresist pattern 22 may expose a portion of the fourth interlayer dielectric 272 disposed on the fourth interconnection 263. Then, a resistive thin film 274 may be deposited on the substrate 212. The resistive thin film 274 may be formed of palladium (Pd).

Referring to FIG. 9O, the photoresist pattern 23 may be removed to form a first resistance pattern 275 on the second interlayer dielectric 246 and form a second resistance pattern 276 on the fourth interlayer dielectric 272. Then, another photoresist pattern 24 may be formed on the substrate 212. The photoresist pattern 24 may expose a portion of both sides of the second interconnection 234 and expose both ends of the first resistance pattern 275. Then, a conductive thin film 280 may be deposited on the substrate 212. The conductive thin film 280 may be formed of gold (Au). Thus, first heat switch pads 282 and 283 may be formed to be connected to both the ends of the first resistance pattern 275, respectively. In addition, second heat switch pads 285 and 286 may be formed to be connected to both the ends of the second resistance pattern 274, respectively. In addition, permanent current injection pads 281 and 284 may be formed to inject permanent current into both sides of the second interconnection 243. The photoresist pattern 24 may be removed. Then, a superconducting thin film 290 may be formed on a back surface of the substrate 212.

According to the above-described embodiments of the present disclosure, an accelerating measuring apparatus of a thin film superconducting coil may improve flatness of a coil to provide more accurate acceleration measurement. In addition, an ultra-compact integrated assembled superconducting acceleration measuring apparatus may be implemented.

Although the present disclosure has been described in connection with the embodiment of the present invention illustrated in the accompanying drawings, it is not limited thereto. It will be apparent to those skilled in the art that various substitutions, modifications and changes may be made without departing from the scope and spirit of the present disclosure.

What is claimed is:

1. An acceleration measuring apparatus comprising:
a test mass structure with a superconducting thin film on one surface of the test mass structure and providing elasticity;
a superconducting coil for measurement disposed on a substrate to be opposite to the one surface of the test mass structure and magnetically coupled to the test mass structure;
a transformer disposed on the substrate and including a primary superconducting coil connected to the superconducting coil and a secondary superconducting coil magnetically coupled to the primary superconducting coil;
an input coil disposed on the substrate and connected to the secondary superconducting coil; and
a superconducting quantum interference device (SQUID) disposed on the substrate and magnetically coupled to the input coil.

2. The acceleration measuring apparatus as set forth in claim 1, wherein the test mass structure includes at least one slit as proceeding from its central axis in a radial direction,
wherein the slit has constant width, and
wherein an angle between a start point and an end point of the slit is 90 degree or greater on the basis of the center of the test mass structure.

3. The acceleration measuring apparatus as set forth in claim 2, wherein the test mass structure includes first to fourth slits disposed by 90-degree rotation with respect to each other, and
wherein the first slit includes:
a first branch having a first radius and extending in an azimuthal direction in the first quadrant;
a second branch having a second radius greater than the first radius and extending in the azimuthal direction in the second quadrant; and
a linear branch extending in a radius direction to connect one end of the first branch to one end of the second branch.

4. The acceleration measuring apparatus as set forth in claim 2, wherein the test mass structure includes:
a test mass disposed at an inner side of the slit;
a support disposed at an outer side of the slit; and
a membrane spring between an inner side region and an outer side region,
wherein thickness of the membrane spring is less than thickness of the test mass and thickness of the support, and
wherein the superconducting thin film is disposed on a bottom surface of the test mass.

5. The acceleration measuring apparatus as set forth in claim 4, wherein the bottom surface of the test mass is dented.

6. The acceleration measuring apparatus as set forth in claim 2, wherein the test mass structure includes first to fourth slits disposed by 90-degree rotation with respect to each other, and
wherein the first slit includes:
a first branch having a first radius and extending in an azimuthal direction in the first quadrant;
a second branch having a second radius greater than the first radius and extending in the azimuthal direction in the second quadrant;
a third branch having a third radius greater than the second radius and extending in the azimuthal direction in the first quadrant; and
a linear branch extending in a radial direction to connect one end of the first branch, one end of the second branch, and one end of the third branch to each other.

7. The acceleration measuring apparatus as set forth in claim 1, further comprising:
a back surface superconducting thin film disposed on a bottom surface of the substrate.

8. The acceleration measuring apparatus as set forth in claim 1, further comprising:
a guide ring disposed around the superconducting coil for measurement to align the test mass and the superconducting coil for measurement.

9. The acceleration measuring apparatus as set forth in claim 1, wherein test mass structure includes a membrane spring.

10. An acceleration measuring apparatus comprising:
a test mass structure including a test mass with a superconducting thin film on its bottom surface and a membrane spring providing elasticity to the test mass, the test mass structure being formed in one body; and
a superconducting quantum interference device (SQUID) sensor module including a superconducting coil for measurement, a transformer, an input coil, and a SQUID and measuring variation of permanent current depending on displacement between the test mass and the superconducting coil.

11. The acceleration measuring apparatus as set forth in claim 10, further comprising at least one of:
a superconducting case storing the test mass structure and the SQUID sensor module;
a vacuum can storing the superconducting case and filled with a helium gas;
an outer container receiving the vacuum can, the inside of the outer container being maintained at a vacuum state;
a heat transfer medium thermally contacting the superconducting case to cool the superconducting case; and
a cryocooler thermally contacting the heat transfer medium and disposed outside the outer container.

12. The acceleration measuring apparatus as set forth in claim 10, further comprising at least one of:
a superconducting case storing the test mass structure and the SQUID sensor module;
a vacuum can storing the superconducting case and filled with a helium gas;
an inner container receiving the vacuum can and filled with a coolant; and
an outer container receiving the inner container and maintained at a vacuum state.

13. A SQUID sensor module comprising:
a superconducting coil for measurement disposed on a substrate and magnetically coupled to an external measurement target;
a transformer disposed on the substrate and including a primary superconducting coil connected to the superconducting coil and a secondary superconducting coil magnetically coupled to the primary superconducting coil;
an input coil disposed on the substrate and connected to the secondary superconducting coil; and
a superconducting quantum interference device (SQUID) disposed on the substrate and magnetically coupled to the input coil.

14. The SQUID sensor module as set forth in claim 13, further comprising:
a permanent current injection pad disposed on an interconnection connecting the primary superconducting coil and the superconducting coil for measurement to each other.

15. The SQUID sensor module as set forth in claim 13, further comprising:
a first resistance pattern disposed on an interconnection connecting the primary superconducting coil and the superconducting coil for measurement to each other; and
a first heat switch pad disposed on the first resistance pattern.

16. The SQUID sensor module as set forth in claim 13, further comprising:
a second resistance pattern disposed on an interconnection connecting the secondary superconducting coil and the input coil to each other; and
a second heat switch pad disposed on the second resistance pattern.

17. The SQUID sensor module as set forth in claim 13, further comprising:
a first interconnection disposed below the primary superconducting coil and the superconducting coil for measured and connected to the primary superconducting coil and the superconducting coil for measured through a via;
a second interconnection connecting the superconducting coil for measurement and the primary superconducting coil to each other;
a third interconnection connecting the secondary superconducting coil and the input coil to each other; and
a fourth interconnection connecting the secondary superconducting coil and the input coil to each other through a via.

18. A fabrication method of a SQUID sensor, comprising:
forming a SQUID on a substrate;
forming a superconducting coil for measurement on the substrate, the superconducting coil for measurement being spaced apart from the SQUID and formed of a superconductor;
forming a primary superconducting coil of a transformer disposed on the substrate and connected to the superconducting coil for measurement;
forming a secondary superconducting coil of the transformer magnetically coupled to the primary superconducting coil; and
forming an input coil magnetically coupled to the SQUID, disposed on the substrate, and connected to the secondary superconducting coil of the transformer.

19. The fabrication method as set forth in claim 18, wherein the superconducting coil for measurement and the primary superconducting coil are formed at the same time.

20. The fabrication method as set forth in claim 18, wherein the secondary superconducting coil and the input coil are formed at the same time.
